(19) United States
(12) Patent Application Publication
(10) Pub. No.: US 2026/0320506 A1
(43) Pub. Date: Oct. 15, 2026

(54) CUSTOMIZING THE APPEARANCE OF TRAVEL SEARCH RESULTS BASED ON A SEARCHED DATE RANGE

(71) Applicant: Expedia, Inc., Seattle, WA (US)

(72) Inventor: Avinash Jha, Castle Rock, CO (US)

(21) Appl. No.: 19/221,281

(22) Filed: May 28, 2025

Related U.S. Application Data
(60) Provisional application No. 63/786,105, filed on Apr. 9, 2025.

(51) Int. Cl. G06Q 10/02; G06F 16/9537; G06Q 50/14

(52) U.S. Cl. CPC G06Q 10/02; G06F 16/9537; G06Q 50/14

(57) ABSTRACT

Systems and methods of the present disclosure generally relate to customizing the appearance of a particular object presented as part of a search result based on a date range associated with a search. A travel service may obtain, for a travel item, at least two date-specific content sets. Each date-specific content set may correspond to a range of dates The travel service may further receive a search query with a searched date range. The travel service may identify the travel property as responsive to the search query. The travel service may then determine a first date-specific content set from the at least two date-specific content sets to display responsive to the search query based on the searched date range falling within the range of dates for the first date-specific content set. The travel service may then display search results including a listing representing the first date-specific content set.

### BACKGROUND

Computing devices, along with computing networks, have become ubiquitous and play an integral role in how individuals gather information and complete purchases. For example, a user, via their personal computing device, can interact with network-based information services to search for, review, and share details regarding items the user is interested in. This also extends to purchasing products a user may want from network-based retailers. The versatility of these network-based services allows users to perform these tasks from the comfort of their own homes or offices, and at their own pace and convenience.

### BRIEF DESCRIPTION OF DRAWINGS

FIG. 1 illustrates components of an example computing environment, which may be used for tailoring search results based on date-specific content sets.

FIG. 2A illustrates an example management interface including date-specific content sets-210B for a travel item.

FIG. 2B illustrates an example search interface including a search result with a date-specific content set.

FIG. 2C illustrates an example search interface including a search result with a date-specific content set.

FIG. 3 illustrates example interactions between a computing device and a travel service to provide customized date-specific content for an object.

FIG. 4 illustrates example interactions between a computing device and a travel service to generate a search result including a date-specific content set for a travel item responsive to a search query.

FIG. 5 illustrates an example method for defining multiple date-specific content sets for a travel item and customizing the appearance of the travel item within search results based on the date-specific content sets.

FIG. 6 illustrates a general architecture for a travel service including an arrangement of computer hardware and software that may be used to implement aspects of the present disclosure.

### DETAILED DESCRIPTION

Generally described, aspects of the present disclosure relate to customizing the appearance of a particular travel item presented as part of a search result based on a date range associated with a search. A lodging may, for example, present differently during different date ranges. A lodging provider may accordingly desire to customize how their lodging appears in search results of a traveler corresponding to a searched date range. However, it may be difficult for a lodging provider to customize the appearance of their lodging in search results based on searched dates in a query. Aspects of the present disclosure advantageously facilitate a provider defining a date-specific content set, such as an image of a lodging during the date range, for a listing of a travel item. The travel item provider may, for example, upload a date-specific content set through a management interface provided by a travel service. The travel service may then generate search results to a query. The travel service may further customize appearance of the travel item within the search results to include content from the date-range specific content set. The search result may include, for example, the image of the travel item from the date-range specific content set.

A travel item may, in some examples, represent a lodging item (e.g., a short term vacation rental) that presents differently at different times of year (e.g., during the summer or winter). Embodiments of the present disclosure can facilitate customization of how the object is presented based on attributes of a search. For example, the lodging item may be presented with pictures taken during the winter season when presented as part of search results for a winter date, while the same lodging item may be presented with pictures taken during the summer season when presented as part of search results for a summer date. In one embodiment, a travel service presenting information regarding travel items may facilitate provision of multiple date-specific sets of content (e.g., images, text, audio, video, etc.) for a travel item. A travel item, as used herein, may refer to a flight, a lodging item (e.g., a hotel, a motel, a bed and breakfast, a short term rental, etc.), a vehicle rental, a restaurant reservation, and the like, or some combination thereof. A lodging item may also be referred to herein as a travel property.

Each set of content for a travel item can be associated with a range of dates, such that specific sets of content may be presented in search results responsive to a search query associated with the range of dates. Provision of multiple date-specific sets of search content for a travel item may advantageously facilitate tailoring search results within the range of dates corresponding to the event to include a date-specific set of content corresponding to the searched date range. A date-specific content set corresponding to an event may also be referred to herein as an event-specific content set.

One method to facilitate presentation of the travel item may be for the travel item provider to invest resources in updating search content displayed for the travel item on the travel service frequently as time passes. A lodging provider may, for example, update a listing with winter-specific content for the lodging close to winter. The lodging provider might update the listing again with spring-specific content, close to spring. However, this may not account for a traveler searching for a travel item very far in advance of their trip dates.

A traveler may, for example, plan a trip well in advance. A traveler may accordingly search for travel items for the trip far in advance of planned dates for the trip. This presents an issue for travel item providers. A traveler may, for example, search in winter for dates of a trip in the summer. With reference to the illustrative example, the lodging provider may have uploaded winter-specific content for the lodging in winter. If the lodging appears in search results presented to the traveler, the traveler may pass over the lodging, since it would be represented by winter-specific content.

Aspects of the present disclosure address these problems, among others, by facilitating provision of multiple date-specific sets of content (e.g., images, text, audio, video, etc.) for a travel item. The travel service may, for example, allow a travel item provider to define multiple events and provide a set of date-specific content corresponding to each event. The definition for each event may further include a date range during which the date-specific content may be presented. The travel service may, as a further example, determine that the travel item is responsive to a search query entered by a traveler. The search query may include a searched date range. The travel service may accordingly return a result corresponding to the travel item and including a date-specific set of search content falling within the searched date range. This may advantageously improve search results presented to the traveler, at least because the search results may be tailored to include representative content relating to the dates searched by the traveler.

The travel service may, in some examples, include a date-specific content management system and a search system. The date-specific content management system may allow the travel item provider to provide multiple date-specific sets of content. The date-specific content management system may, for example, provide a user interface through which a travel item provider can define an event and upload a set of representative content corresponding to a date range for the event. The event definition may further include a date range corresponding to the event.

The search system may facilitate searches by an end user, such as a traveler. The search system may, for example, obtain multiple date-specific sets of content (also referred to herein as “date-specific content sets”). With reference to the illustrative example, a lodging provider may define each season as an event, define a date range for each season, and upload specific content for the date range corresponding to each season. The lodging provider may, for example, upload a snow covered picture of the lodging for winter, the lodging surrounded by trees with autumn colors for autumn, and the like, or some combination thereof.

The search system may further provide a search interface through which a traveler may enter a search query. The search query may be, for example, lodgings during a particular date range. With reference to the illustrative example, the searched date range may fall within a range of dates the lodging provider included in the event definition for winter. The search system may determine the lodging is responsive to the query. The search system may accordingly provide the date-specific content uploaded by the lodging provider in their winter event definition as part of the search results presented to the traveler. The search system may, for example, include a listing of the lodging in the search results presented to the traveler including the winter-specific content set.

The search system may, in some examples, access date-specific content sets uploaded for multiple travel items at regular intervals. The search system may, for example, obtain date-specific content sets uploaded for multiple travel items daily. The search system may subsequently use the obtained date-specific content sets to respond to queries received that day. However, other options are possible.

As another example, the dates-specific content management system may operate as a distinct entity with respect to the search system within a distributed computing environment. The search system may, for example, be controlled by a different entity than the date-specific content management system. The search system may, in further examples, provide a search interface to access search queries. The search system may send a request for date-specific content sets based on a searched date range in a received search query. The search system may further access date-specific content sets corresponding to the searched date range. The search system may, for example, send a request to the date-specific content management system for date-specific content sets responsive to the searched date range (e.g., with dates overlapping the searched date range, failing within the searched date range, etc.). The date-specific content management system may provide the date-specific content sets to the search system. The search system may use the accessed date-specific content sets to identify search results to provide to the traveler. This may advantageously improve an accuracy of search results provided to the traveler at least because the results may be more likely to relate to the searched date range of the search query. This may further advantageously reduce an amount of computing resources required to generate search results for the traveler.

The search system may, in some examples, provide search results for presentation to the traveler based on the accessed date-specific content sets. The search system may, for example, use one or more machine learning models to consider the relevancy of the accessed search specific content sets in light of other known information about the traveler, travel items, geography, and the like, or some combination thereof. With reference to the illustrative example, the search system may access an embedding space trained to include a contextual or semantic understanding of relationships between the traveler, the lodging, the location around the lodging, the season, and the like, or some combination thereof. The search system may provide search results with positions proximate to a representation of first travel item identified as responsive to the search query. The travel items with positions proximate to the representation of the first travel item within the embedding space may be more likely to be responsive to the search query. This approach may thereby improve the search results presented to the traveler by tailoring the search results based on the relationships reflected in the embedding space.

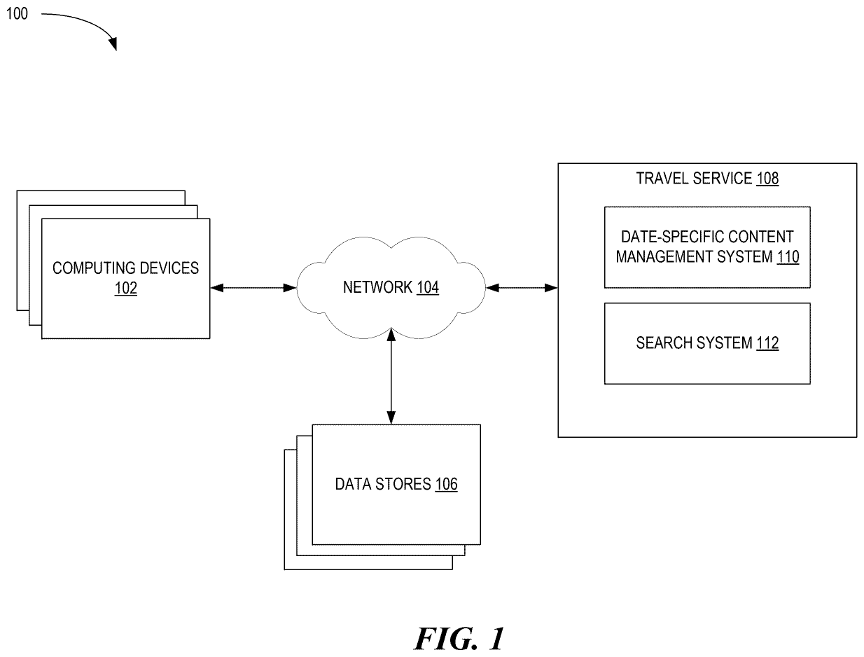

FIG. 1 illustrates components of an example computing environment 100, which may be used for tailoring search results based on date-specific content sets. A travel service 108 may facilitate provision of multiple date-specific content sets for a travel item by a travel item provider. A travel item provider may upload multiple date-specific content sets through a management interface presented through one or more computing devices 102. The date-specific content management system 110 of travel service 108 may, for example, provide the management interface to the travel item provider through a computing device 102. The search system 112 may present a search interface to a traveler through a computing device of computing devices 102. The traveler may enter a search query into the search interface including specification of a date range falling within a date range specified for one of the events defined for the travel item. The search system 112 may determine that the travel item is responsive to the search query. The search system 112 may further provide the date-specific content set for the travel item corresponding to the searched date range. For example, a lodging provider may upload a lodging with a winter-specific content set corresponding to the searched date range. The search system 112 may provide the winter-specific content set in a listing for the lodging included in the search results. This may advantageously improve travel search. For example, this approach may advantageously tailor content included in the listing based on a searched date range at least by customizing the appearance of a particular object presented as part of a search result based on a date range associated with a search.

In general, the one or more computing devices 102 can be any suitable computing device. Suitable computing devices may include, but are not limited to, a desktop, laptop or tablet computer, personal computer, wearable computer, server, personal digital assistant (PDA), hybrid PDA/mobile phone, mobile phone, electronic book reader, set-top box, voice command device, camera, digital media player, and the like, or some combination thereof. The computing devices 102 may be configured to display a management interface through which a travel item provider may upload multiple date-specific content sets for a travel item. This may advantageously reduce an amount of resources used by a travel item provider in customizing content for their travel item based on a range of dates (also referred to herein as “date range”). This may further improve a travel search experience by facilitating presentation of a search result including customized content for an object relevant to a search query including a searched date range.

The lodging provider may, in a further example, upload winter-specific content to the winter event corresponding to a particular range of dates. The winter-specific content may include, but is not limited to, winter images of the lodging, winter videos relating to the lodging, winter textual descriptions of the lodging, winter-related audio, and the like, or some combination thereof. The travel service 108 may subsequently present a traveler searching for lodging stays during dates included in the particular range of dates with a listing of the lodging including the winter-specific content.

Network 104 may be a personal area network, local area network, wide area network, over-the-air broadcast network (e.g., for radio or television), cable network, satellite network, cellular telephone network, and the like, or some combination thereof. As a further example, the network 104 may be a publicly accessible network of linked networks, possibly operated by various distinct parties, such as the Internet. Network 104 may, in some examples, be a private or semi-private network, such as a corporate or university intranet. The network 104 may include one or more wireless networks, such as a Global System for Mobile Communications (GSM) network, a Code Division Multiple Access (CDMA) network, a Long-Term Evolution (LTE) network, or any other type of wireless network. The network 104 can use protocols and components for communicating via the Internet or any of the other aforementioned types of networks. For example, the protocols used by the network 104 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

Data stores 106 may be any suitable type of data stores. Data stores 106 may include one or more data stores. Data stores 106 may include data stores of any suitable types. One or more of data stores 106 may be used to store multiple date-specific content sets. This may advantageously reduce a use of compute resources by a travel item provider in customizing content for their travel. A lodging provider may, for example, use fewer resources in uploading season specific content for their property. Storage of multiple date-specific content sets may further improve travel searches at least by improving relevancy of travel search results for a traveler. A traveler may, for example, receive search results including a listing with a date-specific content set corresponding to their prospective stay dates.

Travel service 108 may be a system which manages travel search, travel bookings, travel purchases, and the like, or some combination thereof. Travel service 108, as illustrated, includes date-specific content management system 110 and search system 112. Travel service 108 may use date-specific content management system 110 to manage interactions with a travel item provider. Date-specific content management system 110 may, for example, obtain multiple date-specific content sets for a travel item from the travel item provider. As one example, the date-specific content management system 110 may present a management interface to a lodging provider through a particular computing device 102 of computing devices 102. The lodging provider may, through the management interface, define events relating to their lodging. The events may include seasons (e.g., “winter,” “spring,” “summer,” “fall,” etc.). The lodging provider may further define a season event to correspond to a particular date range. The lodging provider may, for example, define a winter event to correspond to a range of dates spanning from December XX to January YY. The lodging provider may further provide a date-specific content set corresponding to the event, also referred to herein as an event-specific content set. An event-specific content set for the winter-event may include, but is not limited to, winter images, winter textual descriptions, winter related audio, winter related video, and the like, or some combination thereof.

The travel service 108 may use search system 112 to manage interactions with a traveler. The search system 112 may, with continued reference to the illustrative example, present a search interface to a traveler. The traveler may enter a search query including a searched date range overlapping the range of dates for the winter event. The search system 112 may identify the lodging as responsive to the search query. The search system 112 may accordingly generate search results to the search query including a listing for the lodging. The listing for the lodging may include the event-specific content set corresponding to the winter event. This may advantageously improve travel searching, at least by improving relevancy of the search results provided to the traveler.

In some examples, travel service 108 may operate a distributed computing environment including several computer systems that are interconnected using one or more computer networks (not shown in FIG. 1). The travel service 108 may also operate within a computing environment having a fewer or greater number of devices than are illustrated in FIG. 1. Thus, the depiction of travel service 108 should be take as illustrative and not limiting to the present disclosure.

The travel service 108 or various constituents thereof could implement various Web services components hosted or “cloud” computing environments, and/or peer to peer network configurations to implement at least a portion of the processes described herein. Further the travel service 108 may be implemented directly in hardware or software executed by the hardware devices and may, for instance, include one or more physical or virtual servers implemented on physical computer hardware configured to execute computer executable instructions for performing various features that will be described herein. The one or more servers may be geographically dispersed or geographically co-located, for instance, in one or more data centers. In some instances, the one or more servers may operate as part of a system of rapidly provisioned and released computing resources, often referred to as a “cloud computing environment.”

While FIG. 1 illustrates that travel service 108 includes date-specific content management system 110 and search system 112, other options are possible. The travel service 108 may, in some examples, be remotely connected to date-specific content management system 110. The travel service 108 may, for example, be remotely connected to date-specific content management system 110 through network 104. The travel service 108 may additionally, or alternatively, be remotely connected to search system 112. The travel service 108 may, for example, be connected to search system 112 through network 104.

The date-specific management system 110 may, for example, be a service that serves content to a frontend for other entities. Date-specific management system 110 may, for example, be a backend system that serves content (e.g., date-specific content sets) to search system 112. Search system 112 may use the content to generate responses to queries using any of the methods described herein.

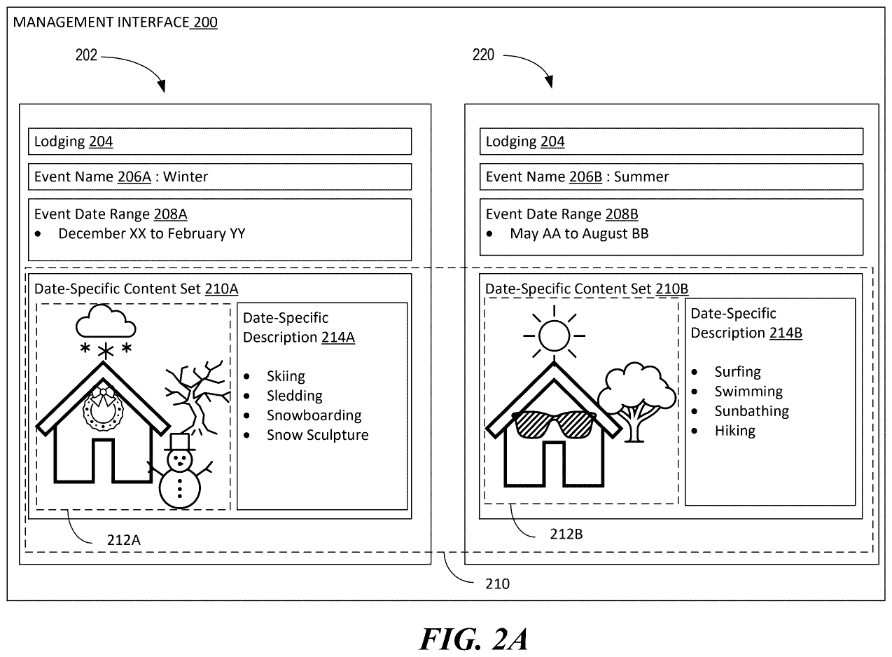

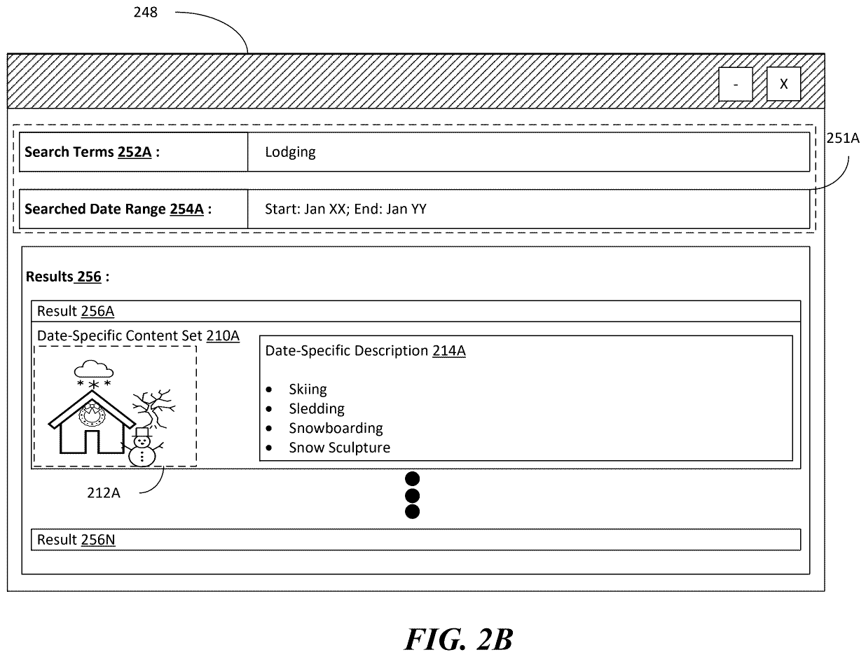

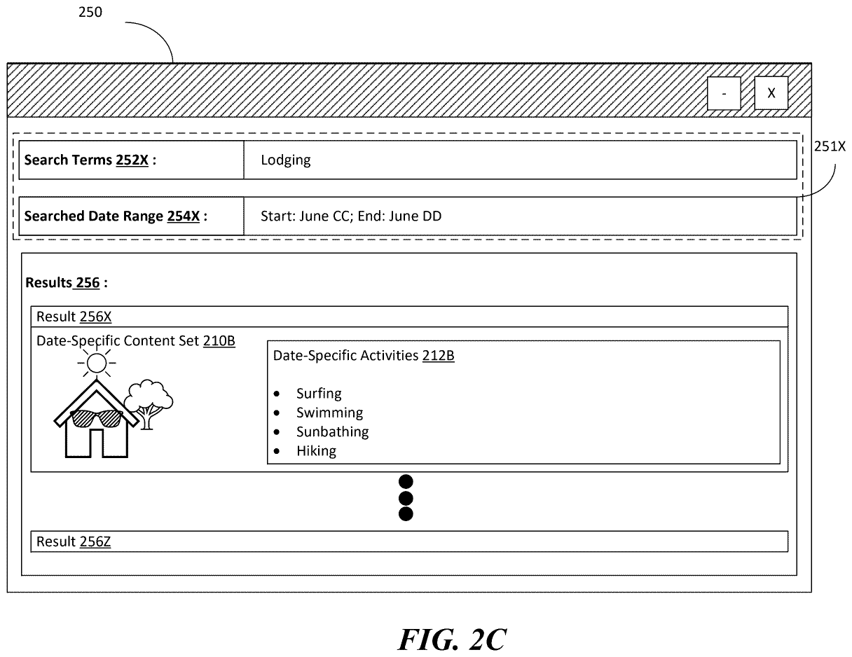

FIG. 2A illustrates an example management interface 200 including date-specific content sets 210A-210B for a travel item. A travel service (e.g., travel service 108 of FIG. 1) may present the management interface 200 to a travel item provider (e.g., through a computing device 102 of FIG. 1). The travel item provider may, as one example, be a lodging provider managing lodging 204. With continued reference to the illustrative example, the lodging provider may define events through management interface 200. The lodging provider may, for example, define, winter event 202 and summer event 220. This may advantageously reduce a use of computing resources for the lodging provider to customize content by a range of dates. This may also improve travel search, at least by improving relevancy of content that may be included in search results to a search query including a searched date range.

The lodging provider may, with continued reference to the illustrative example, define winter event 202 to correspond to an event name 206A of “winter” and an event date range 208A of “December XX to February YY.” The lodging provider may further upload date-specific content set 210A including date-specific image 212A and date-specific description 214A. Date-specific image 212A may represent lodging 204 as it would likely appear during the event date range 208A. Date-specific description 214A as illustrated, includes “skiing, sledding, snowboarding, and snow sculpture.” Date-specific description 214A may represent activities that may be available at or near lodging 204 during event date range 208A.

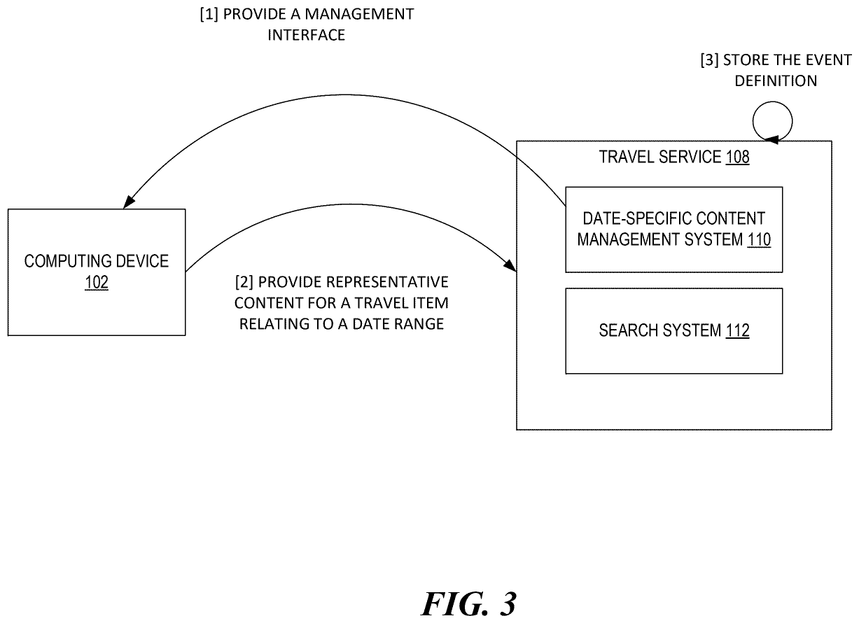

Travel service 108 may, in some examples, facilitate definition of multiple events, including winter event 202. Facilitating definition of multiple events, may advantageously reduce a use of computing resources for the lodging provider to customize content for event date range 208A, as further described herein at least with respect to FIG. 3. Customization of content for event date range 208A may also improve travel search, at least by improving relevancy of content that may be included in search results to a search query including a searched date range within event date range 208A, as further described herein at least with respect to FIGS. 2B-2C and FIG. 3B-4.

The lodging provider may, with continued reference to the illustrative example, define summer event 220 to correspond to an event name 206B of “summer” and an event date range 208A of “May AA to August BB.” The lodging provider may further upload date-specific content set 210B including date-specific image 212B and date-specific description 214B. Date-specific image 212B may represent lodging 204 as it would likely appear during the event date range 208B. Date-specific description 214B as illustrated, includes “surfing, swimming, sunbathing, and hiking.” Date-specific description 214B may represent activities that may be available at or near lodging 204 during event date range 208B.

Travel service 108 facilitating definition of multiple events, including summer event, may advantageously reduce a use of computing resources for the lodging provider to customize content for event date range 208B, as further described herein at least with respect to FIG. 3. Customization of content for event date range 208B may also improve travel search, at least by improving relevancy of content that may be included in search results to a search query including a searched date range within event date range 208A, as further described herein at least with respect to FIGS. 2B-2C and FIG. 4-5.

FIG. 2B illustrates an example search interface 248 including a search result 256A with date-specific content set 210A. A travel service (e.g., travel service 108) of FIG. 1 may provide search interface 248 to a traveler (e.g., through a computing device of computing devices 102 of FIG. 1) to facilitate entry of search query 251A. The travel service 108 may, for example, use a search system (e.g., search system 112 to present search interface 248) to the traveler. The traveler may enter search query 251A including search terms 252A of “lodging” and a searched date range 254A of “Start: Jan XX; End: Jan YY.” The search system 112 may then advantageously generate search results 256 to include date-specific content sets (e.g., date-specific content sets 210A-210B) corresponding to the searched date range 254A.

With reference to the example of FIG. 2A, the searched date range 254A may fall within winter event date range 208A of “December XX to February YY.” The search system 112 may then generate search results 256. As illustrated, search results 256 include search result 256A-search result 256N. Search result 256A may correspond to lodging 204 of FIG. 2A. The search system 112 may, for example, determine lodging 204 or content for lodging 204 is responsive to search query 251A. The search system 112 may then generate the search results 256 to include search result 256A. Search result 256A, as illustrated, includes date-specific image 212A and date-specific description 214A of date-specific content set 210A of FIG. 2A. As described with respect to FIG. 2A, date-specific image 212A may be an image representing lodging 204 during event date range 208A. Date-specific description 214A may be a description of activities available at lodging 204 during event date range 208A. The traveler may accordingly view search result 256A as a representation of lodging 204 as it would be during their searched date range 254A. This may advantageously improve a relevancy of search results 256 with respect to the traveler's search query 251A.

FIG. 2C illustrates an example search interface 250 including a search result 256X with date-specific content set 210B. A travel service (e.g., travel service 108) of FIG. 1 may provide search interface 250 to a traveler (e.g., through a computing device of computing devices 102 of FIG. 1) to facilitate entry of search query 251X. The travel service 108 may, for example, use a search system (e.g., search system 112 to present search interface 250 to the traveler. The traveler may enter search query 251X including search terms 252X of “lodging” and a searched date range 254X of “Start: June CC; End: June DD.” The search system 112 may then advantageously generate search results 256 to include date-specific content sets (e.g., date-specific content sets 210A-210B) corresponding to the searched date range 254X.

With reference to the example of FIG. 2A, the searched date range 254X may fall within summer event date range 208B of “May AA to August ZZ.” The search system 112 may then generate search results 256. As illustrated, search results 256 include result 256X-result 256Z. Result 256X may correspond to lodging 204 of FIG. 2A. The search system 112 may, for example, determine lodging 204 or content for lodging 204 is responsive to search query 251X. The search system 112 may then generate the search results 256 to include search result 256X. Search result 256X, as illustrated, includes event image 212B and date-specific description 214B. As described with respect to FIG. 2A, event image 212B may be an image representing lodging 204 during event date range 208B. Date-specific description 214B may be a description of activities available at lodging 204 during event date range 208B. The traveler may accordingly view search result 256X as a representation of lodging 204 as it would be during their searched date range 254B. This may advantageously improve a relevancy of search results 256 with respect to the traveler's search query 251X.

FIG. 3 illustrates example interactions between a computing device 102 and a travel service 108 to provide customized date-specific content for an object. The interactions of FIG. 3 may, for example, facilitate definition multiple date-specific content sets (e.g., date-specific content sets 210A-210B of FIG. 2A-2C) for a travel item. This may advantageously reduce a use of compute resources by a travel item provider to customize content for their travel item with respect to multiple date ranges.

At [1] of FIG. 3, the date-specific content management system 110 of travel service 108 provides a management interface (e.g., management interface 200 of FIG. 2A) through computing device 102. The management interface 200 may allow a travel item provider to provide a definition of an event relating to a travel item, as further described with respect to [2].

At [2] of FIG. 3, a travel item provider provides representative content for a travel item relating to a date range. The travel item provider may, for example, provide a definition of an event (“event definition,” for brevity). The travel item provider may, in further examples, provide the event definition through the management interface 200 with computing device 102. The event definition may include, but is not limited to, a range of dates for the event, and a date-specific content set (e.g., a date-specific content set 210 of FIG. 2A). The date-specific content set (e.g., a date-specific content set 210 of FIG. 2A) may include multiple modalities of data including, but not limited to, text data, image data, video data, audio data, and the like, or some combination thereof.

With continued reference to FIG. 2A, for example, a lodging provider for lodging 204 may define a winter event 202 in a management interface 200. The winter event 202, as illustrated in FIG. 2A, corresponds to an event date range 208A of December XX to February YY. The winter event 202 further corresponds to date-specific content set 210A. The date-specific content set 210A, as illustrated, includes date-specific image 212A and date-specific description 214A.

The travel item provider may, in some examples, provide representative content for multiple date ranges. With continued reference FIG. 2A, for example, a lodging provider for lodging 204 may define a summer event 220 in a management interface 200. The summer event 220, as illustrated in FIG. 2A, corresponds to an event date range 208A of May AA to August BB. The winter event 202 further corresponds to date-specific content set 210A. The date-specific content set 210B, as illustrated, includes date-specific image 212B and date-specific description 214B.

Other options are also possible. A travel provider may, for example, upload date-specific content without generating an event definition. With reference to FIGS. 2A-2B, for example, the lodging provider for lodging 204 may upload date-specific content set 210A and date-specific content set 210B without defining winter event 202 and summer event 220. The lodging provider may, for example, upload representative content including date-specific image 212A, date-specific description 214A, date-specific image 212B, and date-specific description 214B separately.

The date-range specific content management system 110 may, in further examples, use a generative AI model to separate the representative content into event definitions corresponding to date ranges. The date-range specific content management system 110 may, for example, provide a generative AI model with a prompt relating to defining events. The prompt may include, but is not limited to, default events based on uploaded content, rules for inclusion of representative content into the default events, the representative content, and the like, or some combination thereof. The default events may, as one example, correspond to seasons (e.g., winter, spring, summer, fall, etc.) with default date ranges. Rules for inclusion of representative content into the default events may include, but is not limited to, words that may be included in each default event, alt-text that may represent images to be included in each default event, image content that should be included in each default event, and the like, or some combination thereof. Each default event may, in some examples, be associated with a set of rules for inclusion of representative content into the particular default event.

The date-range specific content management system 110 may, with the generative AI model, sort representative content into a winter event (e.g., winter event 202) with a generative AI model. The generative AI model may, for example, sort representative content into winter event 202 based on one or more rules associated with the winter event 202. The one or more rules may, for example, be included in a set of rules associated with the winter event 202. The prompt may include, as one example, include a rule that text including terms such as skiing, sledding, snowboarding, and snow sculptures should be sorted into a winter event (e.g., winter event 202). The prompt may additionally, or alternatively, include a rule that images with snow should be sorted into winter event 202. The prompt may further include data-specific content for the travel item, such as date-specific image 212A, date-specific description 214A, date-specific image 212B, and date-specific description 214B. The date-range specific content management system 110 accordingly determine to include date-specific image 212A and date-specific description 214A into winter event 202. The date-range specific content management system 110 may further generate winter event 202 to include date-specific image 212A, date-specific description 214A as date-specific content set 210A. The date-range specific content management system 110 may, as another example, determine date-specific image 212B, date-specific description 214B correspond to summer imagery. The date-range specific content management system 110 further generate summer event 220 to include date-specific image 212B, date-specific description 214B as date-specific content set 210B.

While the examples above describe events relating to seasons, other options are also possible. An event may, in some examples, relate to an activity (e.g., a contest, a festival, etc.). The lodging 204 may, for example, be near the location of a clock convention from June EE to June FF. The lodging provider may accordingly provide an event definition to the travel service 108 for the clock convention. The event definition may include a date-specific representative content set (e.g., date-specific content sets 210 of FIG. 2A). The date-specific representative content set 210 may include multiple modalities of data, such as text data, image data, video data, audio data, and the like, or some combination thereof. A date-specific content set 210 for the clock convention may, for example, include textual descriptions of proposed speeches or demonstrations at the clock conventions, images of different types of clocks that may be showcased at the convention, videos of clock making or clock operation, links to podcasts of clock enthusiasts describing past clock conventions, and the like, or some combination thereof. The travel service 108 may receive a search query for a date or date range falling within the date range defined for the clock convention. The travel service 108 may further determine that lodging 204 is responsive to the search query. Travel service 108 may then use the date-specific representative content provided for the clock convention event to customize a representation of the lodging 204 within search results.

There may, in some examples, be overlap between date ranges for events. With continued reference to the illustrative example, the date range for the clock convention event (June EE to June FF) may overlap with the date range for summer event 220 (May AA to August BB). The lodging provider may, in further examples, specify a priority between events with overlapping ranges. The lodging provider may, for example, provide an indication in the management interface 200 that the clock convention event has priority with respect to the summer event 220 (e.g., by selecting a checkbox, etc.). The travel service 108 may generate a listing representing lodging 204 based on this indication in search results for a search query. For example, a searched date range of a search query may fall within the date range of the clock convention event. Based on the indicated priority, the travel service 108 may customize the representation of the lodging with the date-specific content set for the clock convention.

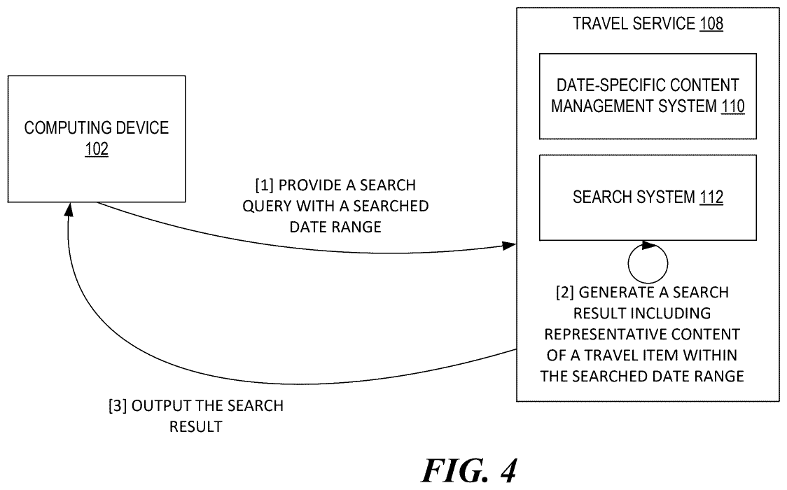

At [3], the travel service 108 stores the event definition. The travel service 108 may store the event definition in any suitable data store. The travel service 108 may, for example, store the event definition in a network accessible data store (e.g., data store 106 of FIG. 1). The search system 112 of travel service 108 may access the stored event definition for use in generating search results for a search query, as further described with respect to FIG. 4.

FIG. 4 illustrates example interactions between a computing device 102 and a travel service 108 to generate a search result including a date-specific content set (e.g., a date-specific content set 210 of FIGS. 2A-2C) for a travel item responsive to a search query. The interactions shown with respect to FIG. 4 may advantageously facilitate customizing the appearance of a particular object presented as part of a search result based on a searched date range. A travel item provider, such as a lodging provider, may provide a date-specific content set 210 for their travel item which falls within the searched date range. A travel service (e.g., travel service 108) may identify the travel item as responsive to the searched query. The travel service utilize the date-specific content set 210 to generate a listing for the travel item within search results provided responsive to the searched query. This may advantageously improve a travel search experience for a traveler.

At [1] of FIG. 4, a computing device 102 provides a search query with a searched date range to travel service 108. A traveler may, for example, provide a search query through a search interface of the travel service 108 displayed through computing device 102. With reference to FIG. 2B, for example, the traveler may submit a search query with search terms 252A (“Lodging”) and Searched Date Range 254A (Start: Jan XX; End: Jan YY) into search interface 248.

At [2] of FIG. 4, the search system 112 of the travel service 108 generates a search result including representative content of a travel item within the searched date range. With reference to FIG. 2B, the travel service 108 may identify lodging 204 as responsive to the search query. The travel service 108 may accordingly generate a listing representing lodging 204 within search results 256 of search interface 248.

Search system 112 may customize the listing based on the searched date range. With reference to FIG. 2B, the searched date range 254 is from Jan XX to Jan YY. The searched date range 254 may fall within the event date range 208A of FIG. 2A, which extends from December XX to February YY. The travel service 108 may accordingly customize the listing representing lodging 204 in the search results using the date-specific content set 210A of winter event 202. Returning to FIG. 2B, for example, travel service 108 generates search result 256A including date-specific content set 210A.

Search system 112 may, in some examples, generate search results with multiple listings customizing the appearance of multiple objects presented as part of a search result based on a searched date range. Travel service 108 may, for example, obtain date-specific content sets 210 for multiple travel items. The date-specific content sets 210 for different travel items of the multiple travel items may, in some examples, be provided by the same travel provider. However, other options are also possible. The date-specific content sets 210 may be provided by different travel item providers. With reference to FIG. 2A, a lodging provider for a lodging 204 may provide date-specific content sets 210A-210B. However, a different lodging provider for a different lodging may provide different date-specific content sets 210.

Returning to FIG. 4, in some examples, the date-specific content sets 210 for different travel items may corresponding to overlapping date ranges. With reference to the illustrative example, a lodging provider for the different lodging may generate an event definition for a clock convention including a date-specific content set corresponding to a date range of June EE to June FF.

The date range for the clock convention for the different lodging may overlap with the date range for summer event 220 of lodging 204. Travel service 108, in further examples, may determine that both lodging 204 and the different lodging are responsive to a search query. With reference to FIG. 2C, for example, a traveler may enter a search query into search interface 250 including search terms 252X (“Lodging”) and searched date range 254X. The travel service 108 may determine that lodging 204 and the different lodging are responsive to the search query. The travel service 108 may further generate result 256X for lodging 204 including date-specific content set 210B. The travel service 108 may further generate a result representing the different lodging including a date-specific content set corresponding to the clock convention.

Returning to FIG. 4, to customize the appearance of a travel item within a search result, travel service 108 may first access the date-specific content set 210A. Travel service 108 may, in some examples, utilize an application programming interface (API) at regular intervals (e.g., hourly, daily, weekly, monthly, etc.) to obtain the date-specific content sets (e.g., date-specific content sets 210 for one or more travel items. The travel service 108 may then use the date-specific content sets 210 to customize search results.

The travel service 108 may, in some examples, access all date-specific content sets 210 within a threshold range of dates. The travel service 108 may, for example, use an API to obtain all date-specific content sets 210 within a threshold range of dates on a daily basis. The threshold range of dates may, as one example, be within zero to fifty days of a particular date. On a particular day, for example, the travel service may use an API to access date-specific content sets for one or more travel items corresponding to date ranges within the threshold range of dates (e.g., zero to fifty days from the particular day)

As another example, the travel service 108 may first receive a search query with a searched date range. Then, based on the searched date range, the travel service 108 may obtain date-specific content sets 210 for travel items that overlap or fall within the searched date range. With reference to FIG. 2C, the searched date range 254X extends from June CC to June DD. Summer event 220 of FIG. 2A corresponds to the event date range 208B of May AA to August BB. Event date range 208B accordingly overlaps the searched date range 254X of FIG. 2C. Travel service 108 may accordingly obtain date-specific content set 210B.

In some examples, the date-specific content management system 110 may operate as a distinct entity with respect to the search system 112 within a distributed computing environment. The search system 112 may, for example, be controlled by a different entity than the date-specific content management system. The search system 112 may, in further examples, provide a search interface to access search queries. The search system 112 may send a request for date-specific content sets(e.g., date-specific content sets 210) based on a searched date range in a received search query. The search system 112 may further access date-specific content sets corresponding to the searched date range. The search system 112 may, for example, send a request to the date-specific content management system 110 for date-specific content sets 210 responsive to the searched date range (e.g., with dates overlapping the searched date range, failing within the searched date range, etc.). The date-specific content management system 110 may provide the date-specific content sets 210 to the search system 112. The search system 112 may use the accessed date-specific content sets 210 to identify search results to provide to the traveler. For example, if the searched date range overlaps with event date range 208A of winter event 202, December XX to February YY, the date specific content management system 110 may provide the search system 112 with date-specific content set 210A.

At [3] of FIG. 4, travel service 108 outputs the search result. With reference to FIGS. 2B-2C, for example, the travel service may generate a search interface (e.g., search interface 248, search interface 250, etc.) including a listing for lodging 204 as a search result (e.g., search result 256A, search result 256X, etc.). The travel service 108 may customize appearance of the search result based on a searched date range of the searched query.

Travel service 108 may, in some examples, provide search results based on the date-specific content sets 210. The travel service 108 may, with reference to FIG. 2A, generate a vector representation of lodging 204 within an embedding space, taking into account date-specific content set 210A and date-specific content set 210B. The travel service 108 may incorporate representations of multiple travel items within this embedding space. The embedding space may thereby capture a semantic or contextual understanding of the travel items with respect to different date ranges (e.g., for seasons, festivals, contests, etc.). Travel service 108 may, for example, determine positions for date-specific representations of travel items within an embedding space using any suitable similarity metric. The travel service 108 may, for example, compute cosine similarity to determine the positions. Positions within the embedding space may accordingly be reflective of date-specific content for the various travel items. The travel service 108 may leverage this embedding space in providing search results representing the travel items responsive to a search query with a particular searched date range. With reference to FIG. 2B, for example, the travel service may provide search results 256 based on a similarity score with respect to a winter concept representation in an embedding space.

As an example, a travel service 108 may identify a first travel item responsive to the searched query. The travel item may, for example, be lodging 204. After identifying lodging 204 as responsive to the query, travel service 108 may further identify a subset of travel items from the embedding space as responsive to the query. The subset of travel items may, for example, be positioned proximate to lodging 204 in the embedding space. Date-specific content of travel items in closer proximity to lodging 204 in the embedding space may, for example, be considered similar to date-specific content of lodging 204. Similarity between date-specific content of travel items may be based on computation of similarity metrics, such as cosine similarity. Travel service 108 may accordingly also return the subset of travel items as responsive to the search query.

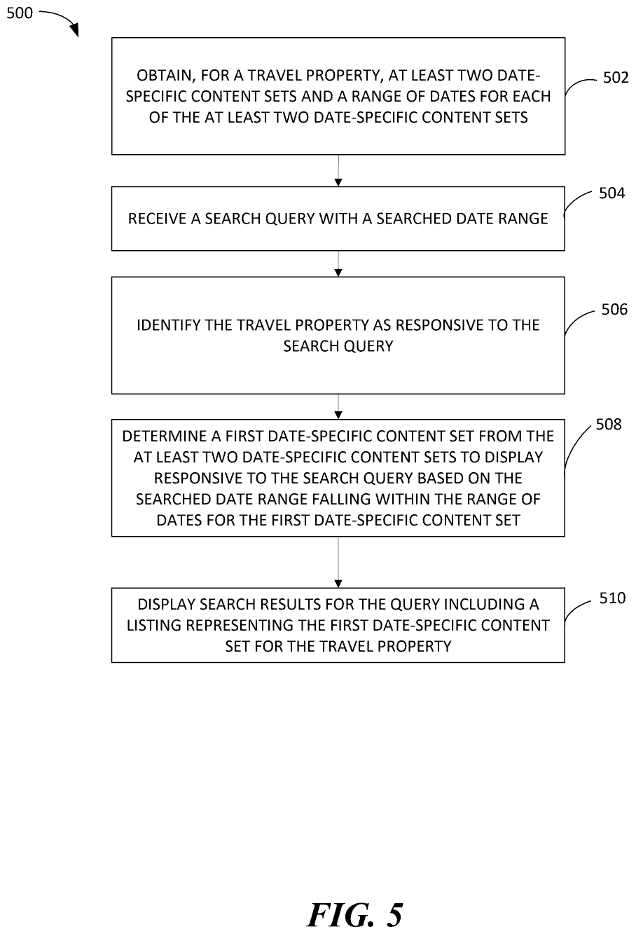

FIG. 5 illustrates an example method 500 for defining multiple date-specific content sets for a travel item and customizing the appearance of the travel item within search results based on the date-specific content sets. A travel service 108 may customize the appearance of the travel item within search results based on the date-specific content sets defined by a travel item provider. This may advantageously reduce a use of resources by the travel item provider to customize content. This may also advantageously improve a traveler's search experience, at least by improving a relevancy of search results within a searched date range provided by the traveler.

Some of the processes, steps, and/or modules discussed herein with respect to FIG. 5 may be combined, separated into sub-parts, omitted entirely, and/or rearranged to run in a different order and/or in parallel. In addition, in some embodiments, different blocks may execute on various components of the travel service 108.

At block 502 of FIG. 5, the travel service 108 obtains, for a travel property, at least two date-specific content sets and a range of dates for each of the at least two date-specific content sets. With reference to FIG. 2A, for example, a lodging provider for lodging 204 may define the winter event 202 and the summer event 220 in a management interface 200. The winter event 202, as illustrated in FIG. 2A, corresponds to an event date range 208A of December XX to February YY. The winter event 202 further corresponds to date-specific content set 210A. The date-specific content set 210A, as illustrated, includes date-specific image 212A and date-specific description 214A. The summer event 220, as illustrated in FIG. 2A, corresponds to an event date range 208A of May AA to August BB. The winter event 202 further corresponds to date-specific content set 210A. The date-specific content set 210B, as illustrated, includes date-specific image 212B and date-specific description 214B.

At block 504 of FIG. 5, the travel service 108 receives a search query with a searched date range. A travel item provider may, for example, provide a search query with a searched date range to travel service 108 using any of the methods described with respect to FIG. 4. With reference to FIG. 2B, for example, the traveler may submit a search query with search terms 252A (“Lodging”) and Searched Date Range 254A (Start: Jan XX; End: Jan YY) into search interface 248.

At block 506 of FIG. 5, the travel service 108 identifies the travel property as responsive to the search query. The travel property may, for example, fall within certain parameters of the search. With reference to FIG. 2B, lodging 204 may be classified as a lodging item. Travel service 108 may accordingly identify lodging 204 as responsive to a search query with search terms 252A (“Lodging”).

Travel service 108 may, in some examples, provide search results based on the date-specific content sets 210. The travel service 108 may, with reference to FIG. 2A, generate a vector representation of lodging 204 within an embedding space, taking into account date-specific content set 210A and date-specific content set 210B. The travel service 108 may incorporate representations of multiple travel items within this embedding space. The embedding space may thereby capture a semantic or contextual understanding of the travel items with respect to different date ranges (e.g., for seasons, festivals, contests, etc.). The travel service 108 may leverage this embedding space in providing search results representing the travel items responsive to a search query with a particular searched date range. With reference to FIG. 2B, for example, the travel service may provide search results 256 based on a similarity metric with respect to a winter concept representation in an embedding space.

As an example, a travel service 108 may identify a first travel item responsive to the searched query. The travel item may, for example, be lodging 204. After identifying lodging 204 as responsive to the query, travel service 108 may further identify a subset of travel items from the embedding space as responsive to the query. The subset of travel items may, for example, be positioned proximate to lodging 204 in the embedding space. Date-specific content of travel items in closer proximity to lodging 204 in the embedding space may, for example, be considered similar to date-specific content of lodging 204. Similarity between date-specific content of travel items may be based on computation of similarity metrics, such as cosine similarity. Travel service 108 may accordingly also return the subset of travel items as responsive to the search query.

At block 508 of FIG. 5, the travel service 108 determines a first date-specific content set from the at least two date-specific content sets to display responsive to the search query based on the searched date range falling within the range of dates for the first date-specific set. With reference to FIG. 2A-2B, the searched date range 254A of FIG. 2B extends from Jan XX to Jan YY. The travel service 108 may determine that the searched date range 254A overlaps with the event date range 208A (December XX to February YY) of FIG. 2A. The travel service 108 may accordingly determine that the date-specific content set 210A of winter event 202 should be displayed responsive to the search query.

At block 510, the travel service 108 displays search results for the query including a listing representing the first date-specific content set for the travel property. With reference to FIG. 2B, for example, the travel service 108 may display search results 256 through search interface 248. Search results 256 include search result 256A. Search result 256A, as illustrated, may be a listing representing the date-specific content set 210A of winter event 202 of FIG. 2A.

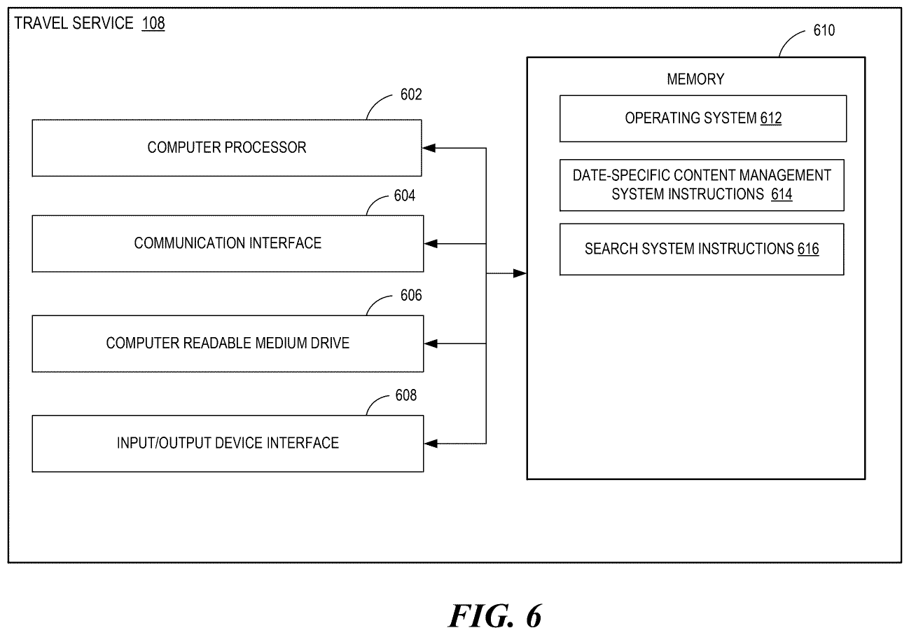

FIG. 6 illustrates a general architecture for a travel service 108 including an arrangement of computer hardware and software that may be used to implement aspects of the present disclosure. The hardware may be implemented on physical electronic devices, as described in greater detail below. The travel service 108 may include more (or fewer) elements than those shown in FIG. 6. It is not necessary, however, that all of these generally conventional elements be shown in order to prescribe enabling disclosure. Additionally, the general architecture stated in FIG. 6 may be used to implement one or more other components illustrated in FIG. 1.

As illustrated, the travel service 108 includes a computer processor 602, a communication interface 604, a computer-readable medium drive 606, an input/output device interface 608, and a memory 610, all of which may communicate with one another by way of a communication bus. The communication interface 604 may provide connectivity to one or more networks or computing systems. The computer processor 602 may thus receive information and instructions from other computing systems or services, such as computing device 102. The computer processor 602 may also communicate to and from memory 610 and further provide output information for an optional display (not shown) via the input/output device interface 608. The input/output device interface 608 may also accept input from an optional input device (not shown).

The computer-readable medium drive 606 may be used in storing data and code. Illustratively, the computer-readable medium drive 606 may be a hard drive that stores data and code. In some examples, the computer-readable medium drive 606 may be an external hard drive communicatively coupled to the travel service 108 (e.g., through a cable). Alternatively, the computer-readable medium drive 606 may be internal to the travel service 108. In some examples, the computer-readable medium drive 606 may be used to carry out any of the functions described below with respect to memory 610.

The memory 610 may store an operating system 612 that provides computer program instructions for use by the computer processor 602 in the general administration and operation of the travel service 108. Memory 610 may further include computer program instructions and other information for implementing aspects of the present disclosure. For example, the memory 610 may include date-specific content management system instructions 614 for implementing the date-specific content management system 110 and search system instructions 616 for implementing search system 112.

Date-specific content management system instructions 614 may illustratively be instructions for implementing date-specific content management system 110, such as instructions for execution of date-specific content management system 110 by computer processor 602. Execution of the date-specific content management system instructions 614 may, for example, cause date-specific content management system 110 to execute any of the operations described herein, at least with respect to FIGS. 2A-5.

Search system instructions 616 may illustratively be instructions for implementing search system 112, such as instructions for execution of search system 112 by computer processor 602. Execution of the search system instructions 616 may, for example, cause search system 112 to execute any of the operations described herein, at least with respect to FIGS. 2A-5.

The travel service 108 of FIG. 6 is one illustrative configuration of such a device, of which others are possible. For example, while shown as a single device, the travel service 108 may, in some examples, be implemented as multiple physical devices.

### Terminology and Other Considerations

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some examples, the computer system may be a cloud-based computing system whose processing resources are shared by multiple distinct business entities or other users.

Depending on the example, certain acts, events, or functions of any of the processes or algorithms described herein can be performed in a different sequence, can be added, merged, or left out altogether (e.g., not all described operations or events are necessary for the practice of the algorithm). Moreover, in certain examples, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the examples disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the examples disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another example, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the examples disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements and/or steps. Thus, such conditional language is not generally intended to imply that features, elements and/or steps are in any way required for one or more examples or that one or more examples necessarily include logic for deciding, with or without other input or prompting, whether these features, elements and/or steps are included or are to be performed in any particular example. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

While the above detailed description has shown, described, and pointed out novel features as applied to various examples, it can be understood that various omissions, substitutions, and changes in the form and details of the devices or algorithms illustrated can be made without departing from the spirit of the disclosure. As can be recognized, certain examples described herein can be embodied within a form that does not provide all of the features and benefits set forth herein, as some features can be used or practiced separately from others. The scope of certain examples disclosed herein is indicated by the appended claims rather than by the foregoing description. All changes which come within the meaning and range of equivalency of the claims are to be embraced within their scope.

What is claimed is:

1. A system comprising:
a computer-readable medium;
one or more processors in communication with the computer-readable medium and programmed by executable instructions to:
obtain, for a travel property, at least two event-specific content sets and a range of dates for each of the at least two event-specific content sets;
receive a search query with a searched date range;
identify the travel property as responsive to the search query;
determine a first event-specific content set from the at least two event-specific content sets to display responsive to the search query based on the searched date range falling within the range of dates for the first event-specific set; and
display search results for the search query including a listing representing the first event-specific content set for the travel property.

2. The system of claim 1, wherein the at least two event-specific content sets are obtained subsequent to receipt of the search query based on the searched date range.

3. The system of claim 1, wherein the at least two event-specific content sets are obtained for a threshold range around a date, prior to receipt of the search query.

4. The system of claim 1, wherein the one or more processors are further programmed by computer-executable instructions to:
receive a second search query for a second searched date range;
identify the travel property as responsive to the second search query;
determine a second event-specific content set from the at least two event-specific content sets to display responsive to the second search query based on the second searched date range falling within the range of dates for the second event-specific content set; and
display search results for the second search query including a listing representing the second event-specific content set for the travel property.

5. The system of claim 1, wherein the one or more processors are further programmed by executable instructions to:
obtain, for a second travel property, at least two event-specific content sets and a range of dates for each of the at least two event-specific content sets;
determine to display a second event-specific content set from the at least two event-specific content sets for the second travel property responsive to the search query; and
display search results for the search query including a listing representing the second event-specific content set for the second travel property.

6. A computer-implemented method comprising:
as performed by a computing system comprising one or more computer processors programmed to execute specific instructions,
obtaining, for a travel item, at least two date-specific content sets and a range of dates for each of the at least two date-specific content sets;
receiving a search query with a searched date range;
identifying the travel item as responsive to the search query;
determining a first date-specific content set from the at least two date-specific content sets to display responsive to the search query based on the searched date range falling within the range of dates for the first date-specific set; and
displaying search results for the query including a listing representing the first date-specific content set for the travel item.

7. The computer-implemented method of claim 6, wherein obtaining, for the travel item, at least two date-specific content sets occurs subsequent to receiving the search query with the searched date range.

8. The system of claim 1, wherein the at least two date-specific content sets are obtained for a threshold range around a date, prior to receiving the search query.

9. The computer-implemented method of claim 6, further comprising:
receiving a second query for a second searched date range;
identifying the travel item as responsive to the second search query;
determining a second date-specific content set from the at least two date-specific content sets to display responsive to the second search query based on the second searched date range falling within the range of dates for the second date-specific content set; and
displaying search results for the second search query including a listing representing the second date-specific content set for the travel item.

10. The computer-implemented method of claim 6, further comprising:
obtaining, for a second travel item, at least two date-specific content sets and a range of dates for each of the at least two date-specific content sets;
determining to display a second date-specific content set from the at least two date-specific content sets for the second travel item responsive to the search query; and
displaying search results for the search query including a listing representing the second date-specific content set for the second travel item.

11. The computer-implemented method of claim 6, further comprising:
dividing the at least two date-specific content sets into the first date-specific content set and a second date-specific content set using a generative AI model at least by:
accessing one or more rules relating to inclusion of data into the first date-specific content set;
generating a prompt comprising the set of rules and content included in the at least two date specific content sets;
providing the prompt to the generative AI model; and
obtaining the first date-specific content set and the second date-specific content set from the generative AI model.

12. The computer-implemented method of claim 6, wherein the first date-specific content set relates to at least one of: a season, a festival, or a contest.

13. The computer-implemented method of claim 6, wherein the travel item is at least one of a lodging item, a flight, a vehicle rental or a restaurant reservation.

14. The computer-implemented method of claim 6, wherein the date-specific content set includes at least two of image data, text data, or audio data.

15. The computer-implemented method of claim 6, wherein the date-specific content set includes at least one of images of the travel item, activities available near the travel item, videos of the travel item or audio relating to the travel item.

16. One or more non-transitory computer-readable media storing instructions that, when executed, cause a computing system to perform operations comprising:
obtaining, for a travel item, at least two date-specific content sets and a range of dates for each of the at least two date-specific content sets;
receiving a search query with a searched date range;
identifying the travel item as responsive to the search query;
determining a first date-specific content set from at least two date-specific content sets to display responsive to the search query based on the searched date range falling within the range of dates for the first date-specific set; and
displaying search results for the query including a listing representing the first date-specific content set for the travel item.

17. The one or more non-transitory computer-readable media of claim 16, wherein the instructions, when executed further cause the computing system to perform operations comprising:
receiving a second query for a second searched date range;
identifying the travel item as responsive to the second search query;
determining a second date-specific content set from at least two date-specific content sets to display responsive to the second search query based on the second searched date range falling within the range of dates for the second date-specific content set; and
display search results for the second search query including a listing representing the second date-specific content set for the travel item.

18. The one or more non-transitory computer-readable media of claim 16, wherein the instructions, when executed further cause the computing system to perform operations comprising:
obtaining, for a second travel item, at least two date-specific content sets and a range of dates for each of the at least two date-specific content sets;
determining to display a second date-specific content set from the at least two date-specific content sets for the second travel item responsive to the search query; and
displaying search results for the search query including a listing representing the second date-specific content set for the second travel item.

19. The one or more non-transitory computer-readable media of claim 16, wherein the instructions, when executed further cause the computing system to perform operations comprising:
dividing the at least two date-specific content sets into the first date-specific content set and a second date-specific content set using a generative AI model at least by:
accessing one or more rules relating to inclusion of data into the first date-specific content set;
generating a prompt comprising the set of rules and content included in the at least two date-specific content sets;
providing the prompt to the generative AI model; and
obtaining the first date-specific content set and the second date-specific content set from the generative AI model.

20. The one or more non-transitory computer-readable media of claim 16, wherein the date-specific content set includes at least one of images of the travel item, activities available near the travel item, videos of the travel item or audio relating to the travel item.
